(19) United States
(12) Patent Application Publication
(10) Pub. No.: US 2005/0161429 A1
(43) Pub. Date: Jul. 28, 2005

(54) Non-symmetrical photo tooling and dual surface etching

(76) Inventor: Andrew Sauciunac, West Seneca, NY (US)

Correspondence Address: COZEN O'CONNOR, P.C., 1900 MARKET STREET, PHILADELPHIA, PA, 19103-3508, US

(21) Appl. No.: 10/503,905

(22) PCT Filed: Feb. 7, 2003
(86) PCT No.: PCT/CA03/00168

Related U.S. Application Data
(60) Provisional application No. 60/354,747, filed on Feb. 7, 2002.

(51) Int. Cl. B44C 1/22

(52) U.S. Cl. 216/41

(57) ABSTRACT

The invention concerns photo etching processes to generate selected shapes and edges on finished articles. In particular, the invention relates to a process for generating sharp edges on blades and sharp edges on the teeth of graters. A non-symmetrical process of etching and photo tooling is employed to generate elongated sharpened edges.

### BACKGROUND OF THE INVENTION

1. Field of the Invention

The invention concerns photo etching processes to generate selected shapes and edges on finished articles. In particular, the invention relates to a process for generating sharp edges on blades and sharp edges on the teeth of graters. The methods of photo-tooling design and etching have been improved to achieve elongated cutting edges having superior functional cutting characteristic while improving productivity in the manufacturing process.

2. Description of the Prior Art

U.S. Pat. No. 4,793,218 (Jordan et al.) teaches a method for forming knife blades from a flat section of pre-hardened metal including the steps of photochemically etching a plurality of blanks from a section of pre-hardened material so that each blank has a predetermined shape, and sharpening at least one edge of each blank by grinding. This prior art patent teaches the use of photo etching techniques for the purpose of forming knife blades generally, but the process produces an etched shape which then requires further sharpening by grinding. This additional process step increases manufacturing times and costs, and produces and produces a lesser quality sharpened edge.

U.S. Pat. No. 5,317,938 (De Juan, Jr. et al.) teaches a method of making a microsurgical cutter comprising the steps of forming a photo resist mask layer on the surface of a pattern for a microsurgical instrument, etching isotropically the top surface of the substrate through the top surface to the bottom surface so that the top and bottom surfaces meet at a cutting edge portion with the cutting edge portion having a configuration corresponding to the edge portion of the mask layer. A photo lithographic mask is applied to both the upper and lower sides of the substrate and both sides are subjected to etching plasma. The etching can be conducted simultaneously or sequentially depending upon the desired etching process until the two surfaces meet and thereby produce an edge portion which constitutes the knife edge.

U.S. Pat. No. 2,842,387 (Marcus) teaches the etching of knife blades having exceptionally sharp cutting edges. The particular contours of the cutting edges are achieved by variable positioning of the photo resist mask layer which is applied to the knife surface. Additionally, sequential applications of mask layers and sequential photo etching steps are also applied to achieve desired blade contours. All of these methods appear to be employed in a system in which etching occurs from one side only. Moreover, the manufacturing costs associated with sequential rounds of photo-etching treatments may be prohibitive in most commercial applications.

It is an object of the present invention to provide an improved chemical machining method for manufacturing sharpened edges on metal members for cutting tools, graters, and the like which overcomes the previously mentioned shortcomings.

### SUMMARY OF THE INVENTION

In accordance with the present invention, a method of manufacturing a sharpened edge on a metal member of the type having a generally flat, first surface, an opposite second surface and a peripheral edge, comprises the steps of applying to the first surface of the metal member a first predetermined pattern of etching resistant material defining unprotected areas separated by resist areas, applying a second layer of predetermined pattern of etching resistant material to the second surface of the metal member at a selected alignment with a selected portion of the resist areas on the first surface of the metal member. The next step is subjecting the first surface of the metal member to a first etching treatment at a first selected rate, and simultaneously subjecting the second surface of the metal member to a second etching treatment at a second selected rate, which second selected rate does not equal the first selected rate. The method then requires continuing the first and second etching treatments to etch through the non-protected areas on both surfaces of the metal member to form a sharpened edge opposite the peripheral edge at a position variable with the ratio of the first to the second selected rates of etching treatment.

In a preferred embodiment of the present invention the ratio of the first to the second selected rates of etching treatment is approximately 70:30.

The position of the sharpened edge relative to and opposite the peripheral edge may be shifted by adding the further step of continuing to simultaneously subject both sides of the metal member to said first and said second etching treatments for a selected time after the metal member has been etched through, so as to shift the sharpened edge toward the second surface of the metal member.

In accordance with another preferred embodiment of the present invention, an elongated sharpened edge may be manufactured by the present method wherein the selected alignment of the second layer is off-set from the selected portion of the protected areas on the first surface of the metal member;

Additional objects, features and advantages will be apparent in the written description which follows.

### BRIEF DESCRIPTION OF THE DRAWINGS

FIG. 1a is a schematic representation of a conventional dual sided symmetrical photo-etching process during application of the etching treatment to both the first and second surfaces of a metal member.

FIG. 1b is a schematic representation of the edge obtained by the conventional symmetrical photo-etching process of FIG. 1a;

FIG. 2a is a schematic representation of a two sided asymmetrical photo-etching process during application of the etching treatment to both the first and second surfaces of a metal member in accordance with the present invention.

FIG. 2b is a schematic representation of the edge obtained by the two sided asymmetrical photo-etching process of FIG. 2a;

FIG. 3 is graphic representation of the photo-tooling pin alignment.

FIG. 4 is a schematic representation of two sided symmetrical exposing process showing the alignment of the first and second layers of etching resistant material being exposed in full alignment.

FIG. 5 is a schematic representation of two sided asymmetrical exposing process showing the alignment of the first and second layers of etching resistant material being exposed in off-set alignment.

FIG. 6 is a schematic representation of the off-set alignment which could be used in the manufacture of sharpened edges on the teeth of graters;

FIG. 7 is a schematic representation of a cross-sectional view of a portion of a metal member and showing in dotted outline the shifting of position of the sharpened edge toward the plane of the second surface of the metal member in accordance with a preferred embodiment of the present invention.

FIG. 8 is a schematic representation of an elongated sharpened edge manufactured in accordance with a preferred embodiment of the present invention;

FIG. 9 is a magnified photograph of an elongated sharpened edge manufactured in accordance with a preferred embodiment of the present invention;

FIG. 10 is a magnified photograph of a sharpened edge manufactured by a conventional photo-etching process.

### DETAILED DESCRIPTION OF THE INVENTION

The present invention utilizes chemical etching to produce sharpened edges on metal members. The word “members” is employed in the description and claims in order to convey the fact that the methods of the present invention are applicable to generating sharpened edges on a metal member of the type having a generally flat, first surface, an opposite second surface and a peripheral edge. These “members” would include knife blades, scalpel or other sharp instrument blades, the teeth of graters, files, saw blades, sharpened contoured openings, and cutters. Additionally, the methods of the present invention may have application in other manufacturing processes where a sharpened edge is required. The processes of the present invention are equally applicable to the creation of sharpened edges on metal members which are essentially finished products once the methods have been carried out, and also to metal blanks which may require sharpened edges, but which may subsequently undergo further secondary processing in order to complete the manufacture of a finished product. For convenience and in accordance with the custom in the industry, the word “blank” may be used in the description, but the use of this word is not intended to limit the scope of the present invention.

Chemical etching techniques are known in the art for making devices or tools having cutting teeth such as files, rasps, saw blades, and the like. A metal blank is provided with those areas of the blank which are to form teeth, ridges or other cutting elements being selectively coated with a material which prevents the etching fluid from contacting and acting on them and other areas of the blank are left exposed for the etching treatment. The etching fluid first acts on the surface areas which are not protected by the resist material, and as the etching proceeds, the material not protected by the resist is removed. The pattern of the resist material which is coated on the blank is varied according to the character of the cutting elements that are desired. For example, a pattern of isolated areas where the etching is to start may be formed in an otherwise continuous etching resist coating, or isolated areas of the etching resist coating may be formed on the otherwise exposed surface areas of the blank. The actual etching fluids and resist materials utilized will be familiar to those skilled in the art and do not form a part of the present invention.

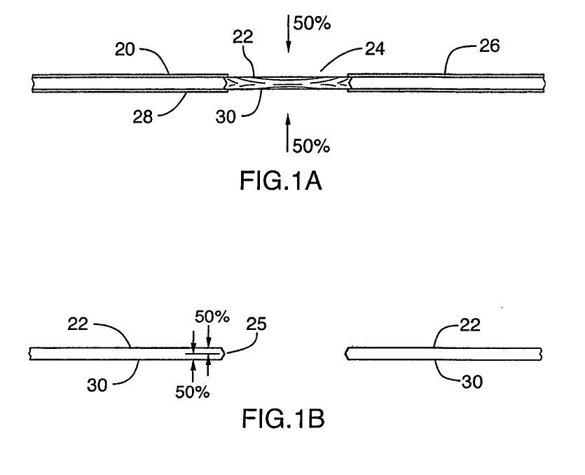

FIG. 1a represents the typical etching process, set up with a goal of removing material equally from the top vs. the bottom (50/50). The result is an even, minimized cusp feature 25, which is inherent to the etching process, and which is illustrated in FIG. 1b. In general the cusp feature 25 is the result of the acid undercutting the photo-resist during the etching process. This continues until the material breaks through from the top and bottom. It is typical for customers to request this feature to be minimized in many acid etched manufacturing applications.

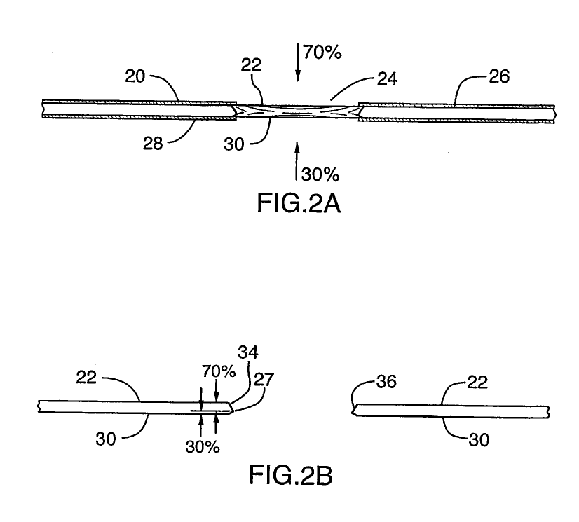

The method of the present invention is an asymmetrical dual-surface etching process. As shown in FIG. 2a, a first layer of etching resistant material 20 is applied to the first surface of 22 metal member in a predetermined pattern, defining unprotected areas 24 of the metal member's first surface separated by resist protected areas 26. A second layer of etching resistant material 28 is applied to the metal member's second surface in a selected alignment with a selected portion of the resist areas on the first side of the member or blank. Accordingly, unprotected areas of the second surface are aligned with and overlie the corresponding exposed areas on the first surface. An etching treatment, preferably an, acid etching spray shown by arrows in FIG. 2a is then applied to both surfaces of the metal blank, etching away the exposed areas of both the back and front surfaces simultaneously. The exposed metal is continually etched from both surfaces until the entire thickness of the metal is etched through.

The process of the present invention for creating sharpened edges requires the removal of more material from one side than the other during the etching process. The asymmetrical removal is a direct result of the subjecting the first surface of the metal member to a first etching treatment at a first selected rate and simultaneously subjecting the second surface of the metal member to a second etching treatment at a second selected rate, which second selected rate does not equal the first selected rate. The ratio of the first to the second selected rates of etching treatment should be greater than 55:45. A ratio of greater than 65:35 is preferred over lesser ratios. The most preferable ratio of the first to the second selected rates of etching treatment is approximately 70:30. The etch ratio is being manipulated by changing variables in the etching process. The primary variable adjusted is the spray pressures in the etching machine.

In accordance with the most preferred embodiment, the metal etched away by the first surface etch treatment accounts for approximately 70% of the thickness of the metal blank while the second surface etching treatment accounts for the remainder of the metal blank surface, being approximately 30%. This change in etch ratio results in an increased cusp 27 as shown in FIG. 2b. This increased cusp facilitates achieving the functional cutting characteristic on the ends of the teeth of the graters after etching. This dual surface etching process results in the formation of a cutting edge located in “the interior” of the metal blank. This means that the cutting edge 27 is between the planes of the first 22 and second 30 surfaces. The etch ratio can be measured on a breakout tab designed in the metal sheet array which is undergoing etching treatment, therefore avoiding destructive measuring.

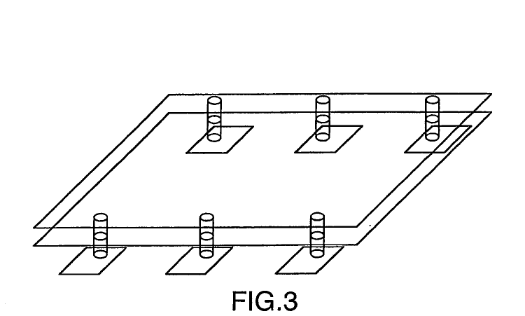

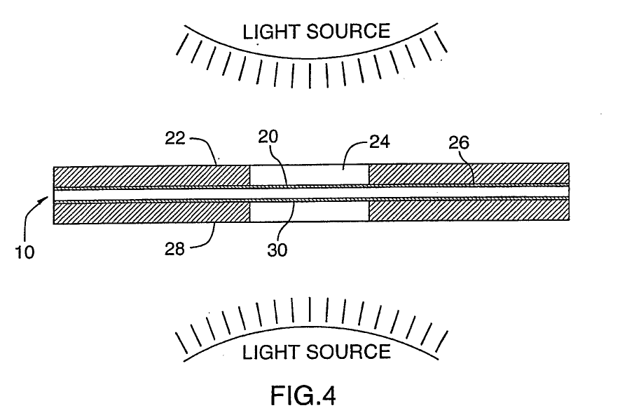

The typical process for photo-tooling design is to generate in-line alignment of masking images, top and bottom, that are pin aligned together, as shown in FIG. 3, for use in the etching process.

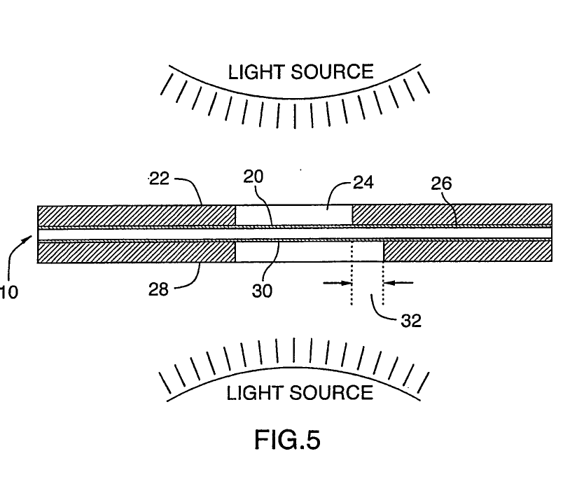

It accordance with the most preferred embodiment, a further elongated sharpened edge can be produced by the method according to the present invention, which works as follows. First, photoresist is applied to a metal blank, substantially as shown in FIG. 5. The photoresist is then exposed by a light source and is selectively masked by photo tooling, 22 and 28 in a non-symmetrical predetermined pattern, leaving exposed resist on the top 20 and bottom 30 surfaces of the metal blank. Specifically the photoresist is exposed so that after developing, an offset 32 exists between the photoresist layers on the top and bottom planes of the metal blank. The exact dimension of the offset is established during the initial design and product testing. As will be discussed in greater detail below, the length of the offset is designed to optimize the cutting edge characteristics and the technical advantages associated therewith.

### EXAMPLE 1

By way of example, a metal blank having a thickness of 0.012 inches. A first and a second layers of etching resistant material are applied to the respective first and second surfaces of the blank in a pre-determined pattern and having a photoresist offset of 0.010 inches is illustrated in FIG. 5. The tolerance currently used for control of etch ratio is ±10%. On a 0.012″ material, etching is 0.0084″±0.0012″ material from the top, and 0.0036±0.0012″ from the bottom.

The etching process requires simultaneously subjecting first surface of the metal blank to a first etching treatment at a selected rate and the second surface of the metal blank to a second etching treatment at a second selected rate, wherein the second selected rate does not equal the first selected rate. A preferred ratio of etching treatment rates is determined for the particular manufacturing application. The primary variable adjusted in order to determine the etching treatment ratio is the spray pressures in the etching acid. It is preferred to apply the etching treatments to the first and second surfaces in a 70:30 ratio, achieved by applying acid spray pressures to the first and the second surfaces in a correlated ratio. When the etch ratio has been verified, the speed of the conveyor through the etching chamber is adjusted based on measurements of final part configuration. The primary features used for control of the etching process are: the tooling holes, width of tooth, width of window, and height of window. After being exposed to the acid spray for a specified period of time, the acid spray will etch through the entire thickness of the metal blank and break through the metal blank from the top and bottom.

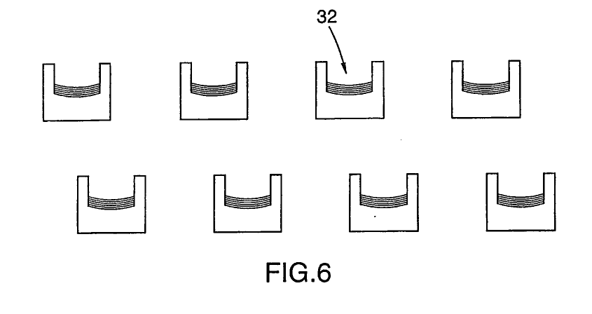

When the etching process of the present invention is practiced using the off-set alignment of the second to the first predetermined patterns of etching resistant material, the exact position of the cutting edge, or cusp 27, can be adjusted by varying the amount of time during which the metal blank is exposed to the acid etching spray. The longer the etching spray is permitted to contact the metal blank the more “under-cutting” will occur behind the respective resists. As the under-cutting continues, the metal is increasingly undercut and the position of the cusp moves closer to the plane edge of the blank. Thus if the acid etching spray is removed or neutralized immediately upon the acid etching “breaking through” the metal blank, the position of the cusp within the thickness of the blank will correlate relatively closely to the ratio of etching from both sides. In other words, if the blank is acid etching spray is applied 70% from a first side and 30% from the second side of the blank until the acid “breaks through” and the metal blank is cut, and then the etching spray is immediately removed/neutralized, the cusp will be at a position approximately 70% of the through the thickness of the blank, as best seen in FIG. 6. If the acid etching spray, applied in the same 70:30 ratio is allowed to remain in contact with the blank longer after the time of “break through”, the effect of the acid etching spray will continue, causing undercutting behind the resist and effectively shifting the position of the cusp toward the plane of the second side of the metal blank, being the side which received the lesser application of the acid etching spray. Accordingly the cusp may be shifted from a position at 70:30 to a position approaching 90:10, or ultimately to a position at the plane of the second side of the blank. Thus, by varying the time of exposure to the acid etching spray following breakthrough in accordance with the present invention, it is possible to selectively position the sharpened edge or cusp, even to the point of obtaining a sharpened edge in the plane of the second side, such as could only previously be produced by a process of etching solely from one side of the metal.

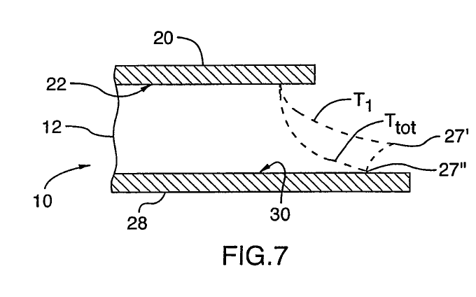

In accordance with the preferred embodiment, FIG. 7 illustrates the formation process by showing the cutting edge 27 at intervals of time during the etching process. From a time 0 to a time T1, the acid etches through the metal until the acid etches through the entire thickness of the blank. This results in an off-plane cutting edge being formed at the point of breakthrough of the etching treatment through the metal member, is indicated by the cusp 27′ on the dotted line labeled T1. From time T1 to time Ttot, the acid continues to be sprayed from both sides, contacting both the top and bottom of the initially formed off-plane cutting edge (dotted line T1). As the acid continues the metal is undercut behind the second layer 28 of photo-resistant material. The vertical position of the cutting edge gradually moves towards the bottom plane of the second surface 30 of the metal blank until time Ttot is reached. At time Ttot, the cutting edge 27″ becomes located approximately the bottom plane. The acid spray is terminated and the metal blank is no longer etched. Thus, the in-plane cutting edge is being formed from etching taking place from both the top and the bottom. Thus, relative to the notional peripheral edge 12, the position of the cutting edge 27 can be shifted toward the second surface 30 of the metal member 10.

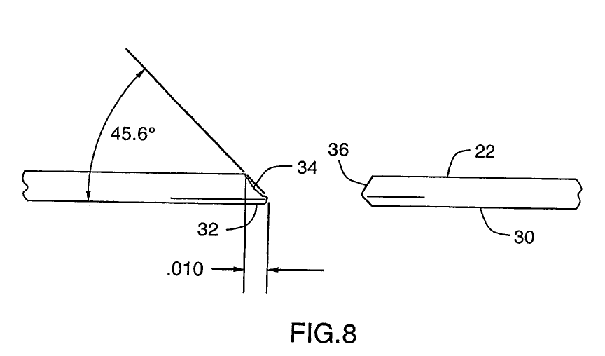

A fully etched metal blank is shown in FIG. 8. As a result of the aforementioned etching process, two edges are formed in the metal blank. A cutting edge, and a non-cutting edge. The cutting edge 34 is formed from the exposed metal that is near the offset segment 32 of the photoresist pattern. The non-cutting edge 36 is formed from the exposed metal that is near the symmetric segment of the photoresist pattern. For the exemplified thickness, offset and material removal ratio, it is estimated that the non-cutting edge will be formed approximately 70% from the top plane and 30% from the bottom plane, while the cutting edge will be formed approximately 85% from the top plane and 15% from the bottom plane.

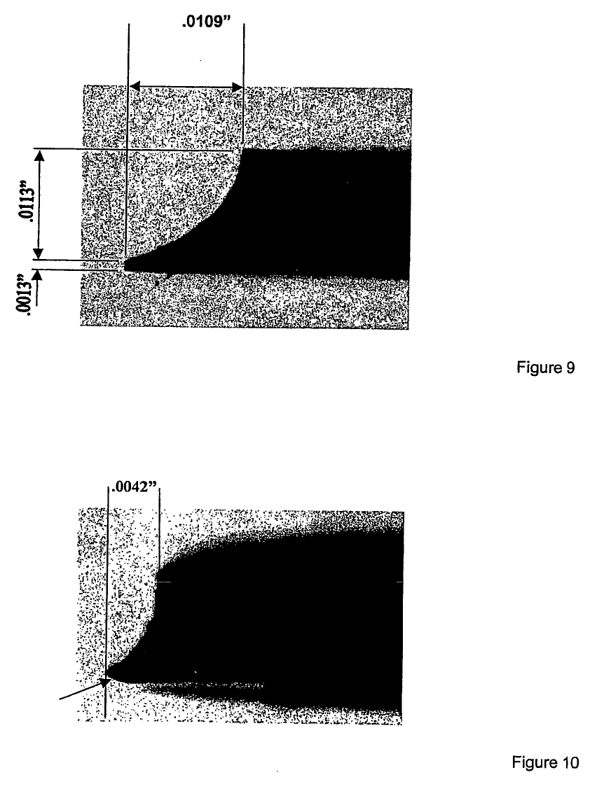

The cutting edges formed by the offset etching process of FIG. 8 results in cutting edges having superior length and incline angle characteristics that can not be achieved by using a single side etching process. The dual-side etching process decreases manufacturing time which results in a considerable economic advantage, which provides a superior elongated cutting edge. Reference may be had to FIGS. 9 and 10 to illustrate the differences between an elongated sharpened edge according to the present invention and an edge produced by conventional single sided etching. The method of the preferred embodiment of the present invention results in a sharpened edge which has a greater length (0.0109 inches) than (0.0042 inches) the conventional edge in the present example. The sharpened edge manufactured in accordance with the present invention can be easily tailored to an application to optimize the length of the cutting edge, sharpness and resistance to wear.

The invention has been provided with several advantages. The photochemically machined cutting tools of the invention have tooth shapes which can be made in any conceivable size, shape or pattern without the use of expensive dies or fixtures. The cutting edges of the tooth shapes are razor sharp, without the necessity of grinding or honing. The cutting tools of the invention are well adapted for use as sheet metal cutting tools including circular and linear wood cutting saw blades, micro-planing blades for hand tools and micro-planing blades for power tools. The files and cutters produced by the method of the invention have teeth with associated slots for removal of material from the work surface. The cutters and files made by the method of the invention are thinner, more flexible, sharper and less likely to load than those made with the prior art techniques. While the invention has been shown in only one of its forms, it is not thus limited but is susceptible to various changes and modifications without departing from the spirit thereof.

1. A method of manufacturing a sharpened edge on a metal member of the type having a generally flat, first surface, an opposite second surface and a peripheral edge, the method comprising the steps of:
a. applying to the first surface of the metal member a first predetermined pattern of etching resistant material defining non-protected areas separated by resist areas;
b. applying a layer second predetermined pattern of etching resistant material to the second surface of the metal member at a selected alignment with a selected portion of the protected areas on the first surface of the metal member;
c. subjecting the first surface of the metal member to a first etching treatment at a first selected rate;
d. simultaneously subjecting the second surface of the metal member to a second etching treatment at a second selected rate, which second selected rate does not equal the first selected rate; and,
e. continuing the first and second etching treatments to etch through the exposed areas on both surfaces of the metal member to form a sharpened edge opposite the peripheral edge at a position variable with the ratio of the first to the second selected rates of etching treatment.

2. The method of claim 1 wherein the ratio of the first to the second selected rates of etching treatment Is greater than 55:45.

3. The method of claim 2 wherein the ratio of the first to the second selected rates of etching treatment is greater than 65:35.

4. The method of claim 3 wherein the ratio of the first to the second selected rates of etching treatment is approximately 70:30.

5. The method of claim 1 wherein the ratio of the first to the second selected rates of etching treatment is achieved by applying elected unequal acid spray pressures to the first and the second surfaces.

6. The method of claim 1 wherein the selected alignment of the second predetermined pattern of etching resistant material is inline alignment with the selected portion of the resist areas on the first surface of the metal member.

7. The method of claim 6, wherein the selected alignment of the second predetermined pattern of etching resistant material is off-set alignment from the selected portion of the resist areas on the first surface of the metal member.

8. The method of claim 7, further comprising a step of:
continuing to simultaneously subject both sides of the metal member to said first and said second etching treatments for a selected time after the metal member has been etched through, so as to shift the sharpened edge toward the second surface of the metal member.

9. A method of manufacturing an elongated sharpened edge on a metal member of the type having a generally flat, first surface, an opposite second surface and a peripheral edge, the method comprising the steps of:
a. applying to the first surface of the metal member a first predetermined pattern of etching resistant material defining un-protected areas separated by resist areas;
b. applying a layer second predetermined pattern of etching resistant material to the second surface of the metal blank at a selected alignment being off-set from the selected portion of the resist areas on the first surface of the metal member;
c. subjecting the first surface of the metal member to a first etching treatment at a first selected rate;
d. simultaneously subjecting the second surface of the metal member to a second etching treatment at a second selected rate, wherein the ratio of the first selected rate to the second selected rate is approximately 70:30;
e. continuing the first and second etching treatments to etch through the exposed areas on both surfaces of the metal member to form an elongated sharpened edge opposite the peripheral edge at a position variable with the ratio of the first to the second selected rates of etching treatment.

10. The method of claim 9, further comprising a step of:
f. continuing to simultaneously subject both sides of the metal member to said first and said second etching treatments for a selected time after the metal member has been etched through to shift the position of the elongated sharpened edge toward the second surface of the member.

11. A sharpened edge on a metal member of the type having a generally flat, first surface, an opposite second surface and a peripheral edge, which sharpened edge is manufactured by the steps of:
a. applying to the first surface of the metal member a first predetermined pattern of etching resistant material defining non-protected areas separated by resist areas;
b. applying a layer second predetermined pattern of etching resistant material to the second surface of the metal member at a selected alignment with a selected portion of the resist areas on the first surface of the metal member;
c. subjecting the first surface of the metal member to a first etching treatment at a first selected rate;
d. simultaneously subjecting the second surface of the metal member to a second etching treatment at a second selected rate, which second selected rate does not equal the first selected rate; and,
e. continuing the first and second etching treatments to etch through the non-protected areas on both surfaces of the metal member to form a sharpened edge opposite the peripheral edge at a position variable with the ratio of the first to the second selected rates of etching treatment.

12. The sharpened edge according to claim 11 wherein the sharpened edge is positioned adjacent the second surface of the metal member by the additional step of
f. continuing to simultaneously subject both sides of the metal member to said first and said second etching treatments for a selected time after the metal member has been etched through to shift the position of the elongated sharpened edge toward the second surface of the member.

13. The sharpened edge according to claim 9 or 11 wherein the sharpened edge is elongated by applying the second predetermined pattern of etching resistant material to the second surface of the metal member at a selected alignment which is off-set from the selected portion of the first predetermined pattern of etching resistant material.
